(19) United States
(12) Patent Application Publication
(10) Pub. No.: US 2022/0366105 A1
(43) Pub. Date: Nov. 17, 2022

(54) ACCURATE AND EFFICIENT NON LINEAR MODEL ORDER REDUCTION FOR ELECTRO-THERMAL ANALYSIS

(71) Applicant: STMicroelectronics S.r.l., Agrate Brianza (MB) (IT)

(72) Inventors: Nicolo FOLLONI, Sedriano (IT); Mattia MONETTI, Vedano Olona (IT); Diego CARRERA, Lodi (IT); Beatrice ROSSI, Milano (IT); Giancarlo ZINCO, Broni (IT); Alberto BALZAROTTI, Corbetta (IT); Pasqualina FRAGNETO, Burago di Molgora (IT)

(73) Assignee: STMicroelectronics S.r.l., Agrate Brianza (MB) (IT)

(21) Appl. No.: 17/244,313

(22) Filed: Apr. 29, 2021

Related U.S. Application Data
(60) Provisional application No. 63/181,550, filed on Apr. 29, 2021.

(51) Int. Cl. G06F 30/23

(52) U.S. Cl. CPC G06F 30/23; G06F 2119/08

(57) ABSTRACT

A method of performing an electro-thermo simulation includes defining a non-linear heat diffusion problem for at least a portion of a semiconductor device to be modeled, performing a finite volume discretization of the non-linear heat diffusion problem, reformulating a non-linear term of the discretized non-linear heat diffusion problem to decrease dimensions thereof, performing a hyper reduction of the reformulated non-linear term, and recovering the non-linear heat diffusion problem for the portion of the semiconductor device, and manufacturing the modeled semiconductor device.

### RELATED APPLICATION

This application claims priority to U.S. Provisional Application for Patent No. 63/181,550, filed Apr. 29, 2021, the contents of which are incorporated by reference in their entirety.

### TECHNICAL FIELD

This disclosure is directed to the field of electro-thermal analysis and, in particular, to the use of electro-thermal analysis to enable the design and implementation of integrated circuit devices and packages that previously would not be able to be successfully implemented.

### BACKGROUND

Devices in the form of integrated circuits (ICs) and packages may drive actuators at high power, leading to high thermal gradients in the IC and, more in general, to high operating temperatures. For this reason, in the development of such ICs and other ICs, forming a precise thermal model of the integrated components in the device has become desired to enable reliable electro-thermal simulations which help facilitate the proper and desired functioning of the device being designed.

While it is possible in theory to have accurate and compact electronic models of the ICs and packages, it is difficult, for example, to generate a precise Dynamic Compact Thermal Model (DCTM) of the system in a reasonable time. Indeed, modern workstations are incapable of generating such DCTM models of the system in a time sufficient so as to permit such models to be regularly used and updated in the course of IC development. When changes to a design cannot be quickly modeled, the modeling becomes of limited use. Models like RC lumped networks (see, document [1]) can accurately model small dimensions and can be computed in a reasonable amount of time, but they unfortunately have low accuracy and are therefore of limited use. On the other hand, Finite Element approaches (see, document [2]) are widely more precise than RC lumped networks, but imply very large models and therefore long simulation time, rendering such techniques of limited use.

A fair trade-off between accuracy and complexity is provided by Model Order Reduction (MOR) methods (see, document [3]). MOR methods generate a compact low-dimensional system that can be efficiently solved, and from that, recover back the original system. The idea behind MOR methods is to find an opportune projection matrix V∈ [symbol] ^{m×\hat{m}}to reduce the dimensionality of the system by projecting it onto an \hat{m}-dimensional subspace, where \hat{m}«m. This is done through a Galërkin projection and the change of variables θ(t)=V\hat{θ}(t), with \hat{θ}(t) being the unknown to the MOR problem and θ(t) the original temperature rise unknown.

Most MOR approaches fall into two categories. The first one includes Singular Value Decomposition (SVD)-based methods (see, documents [4] and [5]), which aim to minimize the error between the reduced model, generated by a projection matrix obtained through SVD, and the full model. The main drawback of these approaches is that they are too computational expensive, since they solve a large number of system configurations in given time instants (snapshots), which takes excessively long using modern workstations. The second category are Multi-Point Moment Matching methods (see, e.g., Krylov subspace projection methods as shown in document [6]), which aim to minimize the error between the moments of the transfer functions of the two systems in full and reduced form (see, document [7]). Based on these Multi-Point Moment Marching methods, several works have been presented, focusing primarily on linear thermal problems (see, documents, [8], [9] and [10]), i.e., problems where the thermal parameters do not depend on the temperature.

Extension of these techniques to non-linear problems have been proposed (see, documents [11] and [12]), where the Multi-Point Moment Matching method is applied to a Volterra series expansion (see, document [13]). However, in the non-linear scenario, such approaches also present a high complexity on the computational front due to the high dimension of the non-linear term of the model, which as explained, renders such techniques inadequate. Another challenge faced in the DCTM generation is non-homogeneity, namely the behavior of different materials forming the region to analyze. In this case, standard discretization approaches often fail to accurately describe the non-linearity of the problem, since no information is available about the temperature on contact interface between different materials. This is of particular concern, since this information would be quite useful during development.

The development of custom package solutions like chip scale packaging makes updating of the electro-thermal modeling necessary each time the design changes, and as explained, existing electro-thermal modeling techniques are inadequate due to being too computationally complex. Moreover, multi-die and stacked-die packages are increasingly used in the field of power electronics, and existing electro-thermal modeling techniques are particularly inadequate in these cases, as they can be even more computationally complex to model. Still further, usable techniques (e.g., not too computationally complex) that can model the temperature at the contact interface between different materials, which would be of particular use in chip scale packaging and multi-die and stacked-die packaging, do not exist as explained.

As such, further development into the area of electro-thermal modeling is needed. An electro-thermal model that could drastically lower the computational complexity and computational time would be of particular interest, as it would enhance the performance of electro-thermal modeling workstations themselves, making them usable in a wide variety of situations in which they are not currently usable.

### SUMMARY

Proposed herein approach are techniques for generating Dynamic Compact Thermal Models (DCTMs) for use in determining non-linear and non-homogeneous heat diffusion in devices, particularly at the interfaces between different mesh elements, using MOR techniques [11]. In particular, a method is disclosed herein for using spatial discretization in generating the model, which introduces additional thermal nodes on the interfaces between different mesh elements. This allows the handling of the non-linear behavior at the contact surface between different materials, and allows the expression of non-linear heat diffusion mathematically as:

$$C \frac{d}{dt} θ ( t ) + K θ ( t ) + {A}_{λ ( t )} θ ( t ) = GP ( t )$$

In this, the non-linear term is modeled through the square matrix A_{λ}(ₜ) instead of utilizing computationally expensive Kronecker's products. Once the model has been discretized, a MOR stage is performed. The convergence of the MOR approach is shown based on Volterra's series expansion, which allows capturing of the non-linear effects of the model at each time step. The compact model of dimension \hat{m} is therefore obtained and has the following form:

$$\hat{C} \frac{d}{dt} \hat{θ} ( t ) + \hat{K} \hat{θ} ( t ) + Δ \hat{K} ( \hat{θ} ( t ) ⊗ \hat{λ} ( t ) ) = \hat{G} P ( t )$$

However, its non-linear term, modeled by a reduced matrix a Δ\hat{K}∈ [symbol] ^{m×\hat{m}}^{²}, would still present a column dimension too large to efficiently solve. Therefore, a further reduction of the non-linear term is performed. This approach is referred to as Hyper Reduction (HR). The specific HR method improved and adapted to for this model is the Energy Conserving Sampling and Weighting (ECSW) method (see, document [14]), and involves selecting a small subset of mesh elements from the original discretization and a relative vector of weights ζ*, such that the non-linear term is well approximated by a weighted linear combination over the selected mesh elements. The selection of such quantities is accomplished through a greedy algorithm, a non-negative variant of the Orthogonal Matching Pursuit. This enables carrying out fast and accurate simulations, without requiring excessive amounts of computing power.

One useful application of this is the interconnection of two or more MOR compact models, allowing the optimization of the computational effort in the analysis of devices which have regions that behave differently under temperature.

To state it more simply, to process the discretized model, prior art MOR techniques are improved using a novel Hyper Reduction approach based on an enhancement and adaptation of an Energy Conserving Sampling and Weighting method. This involves selecting a small subset of mesh elements with opportune weights and evaluating the non-linear terms of the equation only over those samples, thus drastically reducing the computational effort of the process, making the use of such techniques usable in the real world without introducing excessive delay as would be introduced by the use of prior art techniques.

### BRIEF DESCRIPTION OF THE DRAWINGS

FIG. 1 is a block diagram of a computing device on which the electro-thermal simulation technique disclosed herein can be performed.

FIG. 2 is a flowchart illustrating the steps of the electro-thermal simulation technique disclosed herein.

FIG. 3 is a diagram showing sample mesh elements i and j and the contact interface therebetween, and how the electro-thermal simulation technique disclosed herein collocates a thermal node Nᵢ in the centroid of mesh element i, a thermal node Nⱼ in the centroid of mesh element j, and an interface thermal node Nᵢⱼ collocated in the center of the contact interface.

FIG. 4 is a diagram showing how in the electro-thermal simulation technique disclosed herein, a thermal resistance value rᵢ is located between node Nᵢ and node Nᵢⱼ, and a thermal resistance value rⱼ is located between node Nⱼ and node Nᵢⱼ.

FIG. 5 contains graphs showing the correspondence between electro-thermal simulation results using the technique disclosed herein and using a more computationally intensity prior art technique.

### DETAILED DESCRIPTION

The following disclosure enables a person skilled in the art to make and use the subject matter disclosed herein. The general principles described herein may be applied to embodiments and applications other than those detailed above without departing from the spirit and scope of this disclosure. This disclosure is not intended to be limited to the embodiments shown, but is to be accorded the widest scope consistent with the principles and features disclosed or suggested herein.

First, a more detailed mathematical background explaining existing techniques for electro-thermal modeling will be given. Then, the challenges in applying those techniques will be described. Finally, a novel electro-thermal modeling technique developed by the Inventors will be described in detail.

To begin the detailed mathematical background, let Ω⊆ [symbol] ³ be a region describing a device formed from thermally conducting materials with n electrical sources. The thermal behavior of the device can be described by the following non-linear heat diffusion equation, for r∈∩ and t>0:

$$c ( r , t ) \frac{\partial θ}{\partial t} ( r , t ) - ∇ \cdot ( k ( r , θ ( r , t ) ) ∇ θ ( r , t ) ) = {\sum }_{i = 1}^{n} {g}_{i} ( r ) {P}_{i} ( t ) \qquad ( 1 )$$

where θ(r, t) is the unknown temperature rise, c(r, t) is the thermal capacity, k(r, θ(r, t)) is the thermal conductivity, {Pᵢ(t)} are the input powers injected into each source, {gᵢ(r)} are shape functions describing how powers are distributed in Ω. Observe that the problem is non-linear since the thermal conductivity k(r, θ(r, t)) is temperature-dependent. Following the approach described in document [11], assuming the non-linearity to have the form of k(r, θ(r, t))=k₀(r)λ(r, t)+k₀(r), where the auxiliary variable λ(r,t) is expressed as:

$$λ ( r , t ) = {( 1 + \frac{θ ( r , t )}{{T}_{0}} )}^{σ ( r )} - 1 \qquad ( 2 )$$

where k₀(r) and σ(r) are material dependent parameters and T₀ is the ambient temperature. Adopting this non-linearity in equation (1) yields:

$$c ( r , t ) \frac{\partial θ}{\partial t} - ∇ \cdot [ ( {k}_{0} ( r ) λ + {k}_{0} ( r ) ) ∇ θ ] = {\sum }_{i = 1}^{n} {g}_{i} ( r ) {P}_{i} ( t ) \qquad ( 3 )$$

$$( {T}_{0} + θ ) \frac{d λ}{dt} = σ ( r ) ( 1 + λ ) \frac{d θ}{dt} \qquad ( 4 )$$

where the unknowns are θ=θ(r, t) and λ=λ(r, t).

The equation can then be discretized in space by considering a mesh of m elements with a thermal node collocated in each centroid. Several methods may be utilized for this purpose, such as Cell-Center Finite Volumes (see, document [15]). After the discretization, the equation is transformed into a large matrix, as m easily exceeds 10⁶. The direct solution of such a system is too processing intensive for numerical solvers (see, document [2]), and therefore an accurate Dynamic Compact Thermal Model (DCTM) is to be derived.

Here, a Model Order Reduction (MOR) approach (see, document [11]) based on Multi-Point Moment Matching is utilized, where the full system to be solved is projected onto the \hat{m}-dimensional Krylov subspace spanned by the first terms of a Volterra's series expansion of the Laplace transform of the solutions θ(t) and λ(t) through projection matrices V, W∈ [symbol] ^{m×\hat{m}}, with \hat{m}<<m.

A reduced system is thus obtained through Galerkin projection and changing the variables as such:

θ(t)=Vθ(t) λ(t)=W\hat{λ}(t) (5)

The reduced system is then solved by an iterative alternating procedure, fixing one of the unknowns in each of the two equations and solving them with respect to each other during each iteration. Once the solution to the reduced system has been found, original solutions to θ(t) and λ(t) are recovered through equation (5).

When applying the above technique, however, two challenges are to be addressed. The first challenge concerns the discretization of the non-linear terms of equations (3) and (4), namely

$$∇ \cdot ( {k}_{0} ( r ) λ ∇ θ ) , θ \frac{\partial λ}{\partial t} and σ ( r ) λ \frac{\partial θ}{\partial t} .$$

When Ω is non-homogenous, adjacent mesh elements may correspond to different materials that have different thermal behaviors (for example, silicon and oxide). In this case, material dependent parameters k₀(r) and σ(r) vary from one mesh element to another, and therefore the unknowns θ and λ vary as well. To properly recover the non-linear terms, information about the temperature at the contact surface between different elements is to be known, which is not the case when utilizing standard Finite Volume discretization. To handle this issue, a specific discretization procedure able to accurately describe at the same time the non-linear terms and the temperature rises on interfaces between materials is needed, and such discretization procedure will be described below.

Before, however, the second challenge is described. This challenge arises when solving the DCTM through the procedure described above. When \hat{λ} is fixed to solve the system with respect to \hat{θ}, the system dimensions can be reduced to \hat{m} using MOR techniques. However, the non-linear term is still expressed in terms of the full λ, as will be explained below. This makes the resolution of even the reduced system to be quite computationally intensive. Therefore, a further reduction of the system that focuses only on the non-linear terms is needed.

The novel discretization procedure for the non-linear terms in electro-thermo modeling of devices containing non-homogenous materials, developed by the Inventors, is now described.

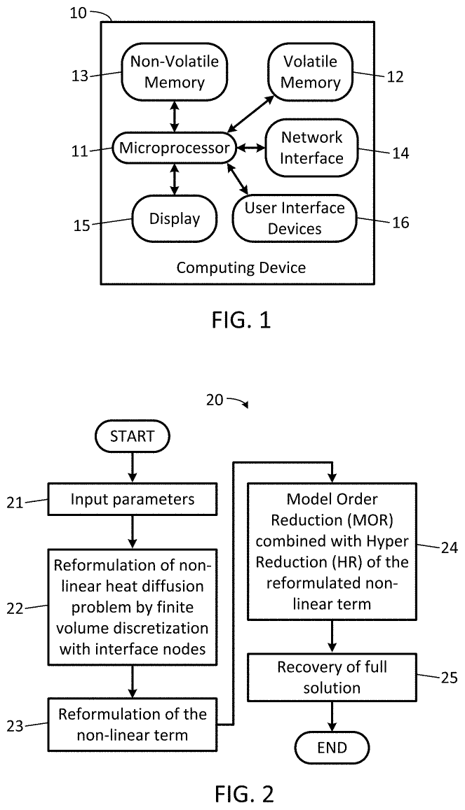

First, the hardware 10 used to perform the electro-thermo modeling of this disclosure will be described with reference to FIG. 1. The hardware 10 may be a computing device, and includes a microprocessor 11 that reads instructions and data from, and writes instructions and data to, a volatile memory 12 and a non-volatile memory 13. The computing device 10 includes a display 15 used by the microprocessor 11 to display data to the user. A network interface 14 is used by the microprocessor 11 to retrieve data from, and send data to, a local area network and/or a wide area network. The computing device 10 includes user interface devices 16 used by the microprocessor 11 to obtain user input.

The non-volatile memory 13 and volatile memory 12 cooperate with the microprocessor 11 to perform the electro-thermo modeling techniques described hereinbelow, with the microprocessor 11 executing instructions stored in the non-volatile memory 13 and/or the volatile memory 12.

With reference to FIG. 2, in general, first input parameters about the device to be modeled are accepted (Block 21), and then a novel finite volume discretization of the non-linear heat diffusion problem by adding novel interface nodes to the traditional set of inner nodes is performed to reformulate the non-linear heat diffusion problem (Block 22), enabling the electro-thermo modeling of devices containing non-homogenous materials. The non-linear term of the problem is reformulated as the application of a smaller operator, depending upon an auxiliary variable, which serves to reduce memory and computational cost of the technique (Block 23). Then, a MOR technique is combined with Hyper Reduction of the reformulated nonlinear term (Block 24) to enable recovery of the full solution (Block 25). It is to be understood that all steps and calculations described below are performed by cooperation between the various components of the hardware 10.

A. Finite Volume Discretization

First, consider the heat diffusion problem in the presence of non-linear thermal conductivity behavior, particularly when the thermal conductivity is not constant and is dependent upon temperature. The general form of the non-linear heat diffusion problem to solve is:

$$c ( r , t ) \frac{\partial θ}{\partial t} ( r , t ) - div ( k ( r , θ ( r , t ) ) ∇ θ ( r , t ) ) = g ( r , t ) \\ - k ( r , θ ( r , t ) ) \frac{\partial θ}{\partial n} ( r , t ) = h ( r , θ ( r , t ) ) θ ( r , t )$$

where θ(r, t) is the unknown temperature rises in the device being modeled, c(r, t) is the thermal capacity, k(r, θ, r, t)) is the non-linear thermal conductivity, h is the boundary heat exchange coefficient, and g(r) is the shape function modeling the electrical behavior of the device being modeled.

In document [11], the following auxiliary variable is introduced:

$$λ ( r , t ) = {( 1 + \frac{θ ( r , t )}{{T}_{0}} )}^{σ ( r )} - 1$$

The introduction of λ(r,t) allows rewriting of the heat diffusion problem so that only quadratic non-linearities occur:

$$c ( r , t ) \frac{\partial θ}{\partial t} ( r , t ) - div [ ( {k}_{0} ( r ) λ ( r , t ) + {k}_{0} ( r ) ) ∇ θ ( r , t ) ] = {\sum }_{i = 1}^{n} {g}_{i} ( r ) {P}_{i} ( t ) \\ ( {T}_{0} + θ ( r , t ) ) \frac{\partial λ}{\partial t} ( r , t ) = σ ( r ) ( 1 + λ ( r , t ) ) \frac{\partial θ}{\partial t} ( r , t )$$

The unknowns then become θ(r,t) and λ(r,t), and the thermal capacity parameter is c(r,t) while the material dependent thermal conductivity parameter is k₀(r).

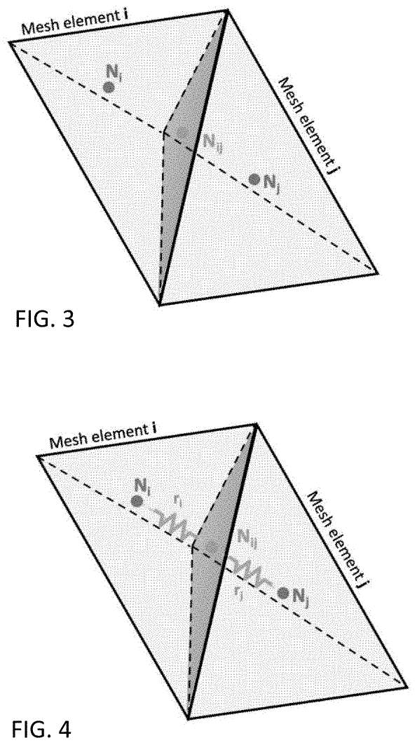

The problem can be discretized as follows. The domain of the device to be modeled can be split into m tetrahedrons. An inner thermal node Nᵢ can be collocated in the centroid of each mesh element (tetrahedron) with i=1, . . . ,m. Then, an additional interface node Nᵢⱼ can be collocated in the center of each contact surface between an Nᵢ tetrahedron and an Nⱼ tetrahedron. This is visually represented in FIG. 3.

Then, the interconnection structure is derived from the coupled electrical problem, as shown in FIG. 4. For each additional interface node Nᵢⱼ, two more thermal resistance values are considered, namely the resistance rᵢ occurring in the connection between the inner node Nᵢ and the interface node Nᵢⱼ, and the resistance rⱼ occurring in the connection between the interface node Nᵢⱼ and the inner node Nⱼ. Overall therefore, this results in a total number of inner thermal nodes plus a total number of interface thermal nodes, this sum being denoted as mₑ.

The discretized non-linear heat diffusion problem then becomes:

$$C \frac{\partial }{\partial t} θ ( t ) + K θ ( t ) + Δ K ( θ ( t ) ⊗ λ ( t ) ) = GP ( t ) \\ {T}_{0} N \frac{\partial λ}{\partial t} ( t ) + Δ N ( θ ( t ) ⊗ \frac{\partial λ}{\partial t} ) = M \frac{\partial θ}{\partial t} ( t ) + Δ M ( \frac{\partial θ}{\partial t} ( t ) ⊗ λ ( t ) )$$

The matrices C, K, and G respectively describe thermal capacity, thermal conductivity between each mesh element, and the fraction of power dissipated in each node. P(r) is the vector containing the electrical powers for each source.

The matrix C is computed as a diagonal matrix of thermal capacity, with entry cᵢᵢ≠0 if the index i refers to an inner node, with i=1, . . . ,mₑ.

The matrix G is computed as a diagonal matrix of dissipated power, with entry gᵢᵢ≠0 if the index i refers to an inner node, with i=1, . . . ,mₑ.

The matrix K is computed as a mₑ×mₑ matrix, with kᵢⱼ=−rᵢ if i≠j and the resistance occuring in the connection is between Nᵢ and Nᵢⱼ, and kᵢⱼ=the sum in absolute value of the elements of the row if i=j.

The matrix N is an m×m identity matrix, and M is a diagonal m×m matrix where mᵢⱼ=σ(Nᵢ), with σ being a material dependent function.

B. Reformulation of the Non-Linear Term of the Problem

The non-linear term in the now discretized problem is given by:

ΔK(θ(t)⊗λ(t))

with λ(r,t) being fixed and independent from r, or, equivalently, λ(r,t)=λ(t).

The nonlinear matrix ΔK has a size of mₑ×(m·mₑ) and is sufficiently large such that it is not desirable to be stored in the volatile memory or employed in computations. As such, the nonlinear term is rewritten by finding a squared matrix A_{λ(t)} of size mₑ×mₑ such that:

ΔK(θ(t)⊗λ(t))=A_{λ(t)}θ(t)

A_{λ(t)} is computed as follows. Each diagonal value kᵢᵢ of the matrix K is replaced with the non-linear resistance value λ(Nᵢ,t)kᵢᵢ. Each term λ(Nᵢ,t) is computed in the inner nodes as follows:

$$λ ( {N}_{i} , t ) = {( 1 + \frac{θ ( {N}_{i} , t )}{{T}_{0}} )}^{σ ( {N}_{i} )} - 1$$

It can be observed that A_{λ(t)} depends on the discretization described herein and on the thermal conductivity matrix K. This reformulation of A_{λ(t)} allows simplification of the non-linear term as the operator A_{λ(t)} has a size of mₑ×mₑ while ΔK has a size of mₑ×(m·mₑ)—this step is particularly useful and novel, as it greatly reduces the computing and memory overhead used by the simulation techniques described herein, and greatly reduces the computation time for such simulation techniques.

C. Hyper Reduction of the Reformulated Non-Linear Term

Non-linear MOR techniques are dimensionality reduction techniques that compute projection matrices V,W able to derive a compact form for the discretized non-linear heat diffusion problem:

$$\hat{C} \frac{\partial }{\partial t} \hat{θ} ( t ) + \hat{K} \hat{θ} ( t ) + Δ \hat{K} ( \hat{θ} ( t ) ⊗ \hat{λ} ( t ) ) = \hat{G} P ( t ) \\ {T}_{0} \hat{N} \frac{\partial \hat{λ}}{\partial t} ( t ) + Δ \hat{N} ( \hat{θ} ( t ) ⊗ \frac{\partial \hat{λ}}{\partial t} ) = \hat{M} \frac{\partial \hat{θ}}{\partial t} ( t ) + Δ \hat{M} ( \frac{\partial \hat{θ}}{\partial t} ⊗ \hat{λ} ( t ) )$$

The matrix V has a size of \hat{m}×mₑ and W has a size of \hat{m}×m, where mₑ>m>>\hat{m}. Reduced matrices are then defined as follows:

Ĉ=V^{T}CV \hat{m}×\hat{m}

\hat{K}=V^{T}KT \hat{m}×\hat{m}

Δ\hat{K}=V^{T}ΔK(V⊗W) \hat{m}×\hat{m}²

Ĝ=V^{T}G \hat{m}×\hat{m}

\hat{N}=W^{T}NW \hat{m}×\hat{m}

\hat{M}=W^{T}MV \hat{m}×\hat{m}

Δ\hat{N}=W^{T}ΔN(V⊗W) \hat{m}×\hat{m}²

Δ\hat{M}=W^{T}ΔM(V⊗W) \hat{m}×\hat{m}²

The calculation of the matrices ΔK, ΔM, and ΔN is as follows:

ΔK=Σᵢ₌₁^{m}Aₑ_{ᵢ}⊗eᵢ^{T}

ΔM=Σᵢ₌₁^{m}M⊗eᵢ^{T}

ΔN=Σᵢ₌₁^{m}N⊗eᵢ^{T}

where eᵢ=(0, . . . , 0, 1, 0, . . . , 0)^{T} is the ith vector of the basis of the m-dimensional Euclidean space.

The projection matrices V and W are computed using a non-linear MOR technique based upon Moment Matching and Krylov subspaces. Here, the matrices V and W span a set of solutions of the non-linear problem evaluated in a set of frequencies in the Laplace domain.

The reduced non-linear matrix ΔK has a size of \hat{m}×\hat{m}², and Hyper Reduction techniques are employed to further reduce the number of columns in the reduced non-linear matrix ΔK. Through this, a subset of the original full mesh volumes is identified and appropriate weights are applied such that the weighted reduced mesh volumes well approximate the original problem.

In particular, Energy-Conserving Sampling and Weighting (ECSW) is applied to the reduced non-linear matrix ΔK. It begins with a collection of s snapshots of the solution to the non-linear problem in a set of complex frequencies in the Laplace domain, resulting in a matrix U having dimensions of mₑ×s and a matrix A having dimensions of m×s.

Through the definition of ΔK, construction of a matrix H representing the unassembled contributions of the non-linear forces and a vector b occurs as follows:

Hᵢₑ=V^{T}*∧(e,i)*Aₚₑ*U(:,i),

i=1, . . . , s

e=1, . . . , m

b=H*(1, . . . , 1)^{T}

Resolution of the following sparse minimization problem with a non-negative variant of the orthogonal matching pursuit algorithm is then performed as:

ξ*=argmin_{ξ}∥Hξ−b∥_{F} s.t.ξ≥0 and ∥ξ∥₀<w

The solution of the problem ξ* represents the sparse vector of weights, and a set E can then be defined as the indices of the non-zero entries of ξ*. Computation of the non-linear model order reduced term is performed by evaluating it on the volumes indexed by E and weighted with relative ξ*, as follows:

Δ\hat{K}(\hat{θ}(t)⊗\hat{λ}(t))≈(Σₑ₌₁^{w}ξ*(e)*W(e,:)*\hat{λ}(t)*V^{T}Aₚₑ*V)*\hat{θ}(t)

To further increase the computation speed, a singular value decomposition (SVD) is performed on the terms V^{T}*Aₚₑ*V for e=1, . . . , w, further reducing the complexity of the computations.

To recover the full solution (i.e., the equivalent simulation result as if the full prior art simulation technique was used), the Hyper Reduced problem is solved and the reduced solution is computed: \hat{θ}(t) and \hat{λ}(t). Then, the full solution is recovered from the reduced solution, using the projection matrices V and W:

θ(t)=V\hat{θ}(t) λ(t)=W\hat{λ}(t)

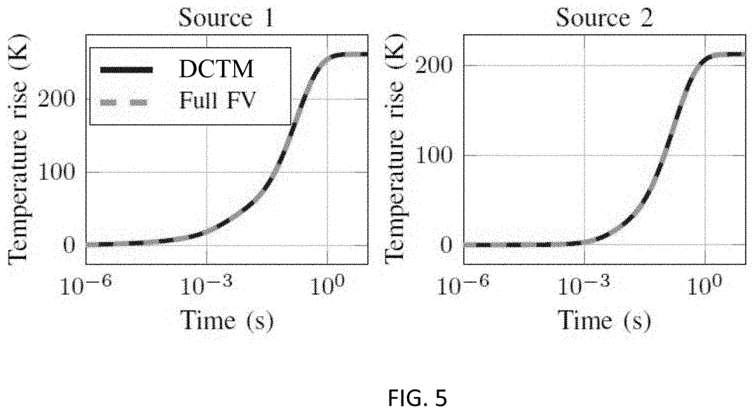

A comparison between the results using the DCTM technique described herein and a prior art finite volume model was made. Using the DCTM technique, 65 minutes of computing time was used to compute the projection matrices V, W, and the vector ξ*, and this calculation is performed but once since it depends solely on the domain Ω. Multiple thermal simulations for different injected powers of Pi were performed, each taking but 12.160 seconds to perform. For comparison, the prior art finite volume model required 197 minutes of computing time. An accuracy comparison between the DCTM technique described herein and the prior art finite volume model can be seen in FIG. 5, where it can be observed that the results are nearly identical.

D. Improvements to Electro-Thermo Simulation Technology and Computing Devices Performing Electro-Thermo Simulations

In greater detail, the structure of Smart Power devices is, to date, primarily based on silicon. However, silicon is not the only material utilized in such devices—copper and aluminum are employed in the interconnections of the device, while different oxides are used to isolate different regions. In particular, silicon oxide is adopted to create microstructures within the silicon parts, such as Deep Trench Isolations (DTI) and Silicon on Insulator (SOI), to improve the electrical properties of the device.

On the other hand, silicon oxide is a poor heat conductor. As a consequence, the adoption of such solutions and the significant increase of the power density (due to the miniaturization of the devices) result in a drastic rise of the operation temperatures and in the formation of high temperature gradients within the devices.

Therefore, during the design stages of these devices, thermal and electrothermal analysis resulting in an accurate description of the temperature rises within the device are strongly desired to help guarantee its correct operation.

As explained earlier, the structure of these devices, formed of different materials each with a different thermal behavior, results in a thermal problem which is non-linear and difficult to model with standard prior art 3D-discretization methods (e.g., Cell-Centered Finite Volumes). In fact, such techniques fail when describing non-homogeneous structures with significant non-linearities in their materials, thereby not allowing an accurate analysis of sudden temperature variations within the discretized domain.

Conversely, the DCTM techniques described herein provide an extremely accurate description of the non-linear behavior of the materials forming the device, regardless of their structure. This allows the realization of accurate simulations even under the high temperatures at which Smart Power devices work, which may not be possible with prior art techniques. Moreover, due to the application of Model Order Reduction (MOR), the extraction of dynamic compact thermal models has been accomplished, resulting in simulations which are not only accurate but also extremely fast, as also explained earlier.

The Smart Power industry is currently facing significant changes and challenges—new materials like gallium nitride (GaN) and silicon carbide (SiC) will be integrated in Smart Power devices, making the resulting structure extremely complex to analyze and the temperature rise reached during operation even higher.

Therefore, the discretization techniques described herein not only drastically improve over prior art simulation frameworks, but provide for adequate accuracy to handle the analysis on future devices.

To better understand the usefulness of the accurate electro-thermal analysis provided by the techniques described herein, consider the simple example of a short-circuit control system of a power output of a voltage regulator. The system needs to be able to detect a short-circuit downstream of the output. Therefore, the output current has to be assessed and the power supply stopped in order to avoid damages to the device. When a short-circuit occurs, the current used in the device significantly increases and, as a consequence, so does the dissipated power.

The sizing of the device is aimed at guaranteeing its functioning during its operational life. A sudden increase of the dissipated power can force the device to a very high temperature rise for a short time span (before the interruption of the power supply). Such temperature rise may come close to the critical temperature of the device. The critical temperature is a threshold which, when is overcome (due to the leakage effects of the current), results in a further increase of the dissipated power. This, due to the exponential form of the leakage currents, can cause destructive phenomena. The value of the critical temperature is different for each device, but is known a priori.

Electro-thermal simulations allow forecasting of the behavior of the device, however, it is important to provide an accurate description of the thermal model in order to obtain reliable results.

Given the exponential form of the electrical effects at stake, if a model overestimates the temperature rises during the simulation, the resulting device will be oversized, employing an unnecessary area, and increasing the final cost of the product. On the other hand, if a model underestimates the temperature rises, the device will be undersized, and therefore more subject to be damaged when a short-circuit occurs during its functioning.

Both scenarios are to be prevented: in one case the device cost would be too high, hindering competitiveness on the market, while in the other the expenses to redesign the device and the management of the return from the field costs would cause a significant economical loss and image damage for the company. The electro-thermal simulation and analysis techniques described herein facilitate the prevention of both scenarios, using fewer computing and memory resources, in a shorter period of time, representing an advance in electro-thermal modeling technology itself, as well as representing an improvement in the operation of workstation computers performing electro-thermal modeling.

The introduction of additional thermal nodes on the surfaces of contact between mesh elements in the DCTM techniques described herein leads to several advantages. First of all, it allows description of the non-linear behavior of different materials (e.g., silicon and oxide). Although introducing additional nodes increases the dimension of the problem, the resulting structure of the matrices defining heat diffusion is computationally easier to handle. In fact, the new matrices present a large amount of non-zero elements and their structure allows linearization of the heat diffusion equation, drastically reducing the complexity of the algorithm in both the MOR and the Hyper Reduction stages.

Listing of documents referenced herein:

[1] Vladimir Szekely, “On the representation of infinite-length distributed rc one-ports,” IEEE Transactions on Circuits and Systems, vol. 38, no.7, 1991.

[2] Olek C Zienkiewicz, Robert L Taylor, and Jian Z Zhu, “The finite element method: its basis and fundamentals,” Elsevier, 2005.

[3] Wilhelmus H A Schilders, Henk A Van der Vorst, and Joost Rommes, “Model order reduction: theory, research aspects and applications,” Springer, 2008.

[4] Anindya Chatterjee, “An introduction to the proper orthogonal decomposition,” Current Science, vol. 78, no. 7, 2000.

[5] Francisco Chinesta, Pierre Ladeveze, and Elias Cueto, “A short review on model order reduction based on proper generalized decomposition,” Archives of Computational Methods in Engineering, vol. 18, no. 4, 2011.

[6] Pieter Jacob Heres, “Robust and efficient Krylov subspace methods for model order reduction,” Ph.D. thesis, Technische Universiteit Eindhoven, 2005.

[7] Yehea I Ismail, “Efficient model order reduction via multi-point moment matching,” 2004, U.S. Pat. No. 6,789,237.

[8] Lorenzo Codecasa, Dario D'Amore, and Paolo Maffezzoni, “Compact modeling of electrical devices for electrothermal analysis,” IEEE Transactions on Circuits and Systems I: Fundamental Theory and Applications, vol. 50, no. 4, 2003.

[9] Lorenzo Codecasa, Vincenzo d′Alessandro, Alessandro Magnani, Niccolo Rinaldi, and Peter J Zampardi, “Fast novel thermal analysis simulation tool for integrated circuits (fantastic),” in International Workshop on Thermal Investigations of ICs and Systems, 2014.

[10] Lorenzo Codecasa, Dario D′Amore, and Paolo Maffezzoni, “An arnoldi based thermal network reduction method for electro-thermal analysis,” IEEE Transactions on Components and Packaging Technologies, vol. 26, no. 1, 2003.

[11] Lorenzo Codecasa, Vincenzo d′Alessandro, Alessandro Magnani, and Niccolo Rinaldi, “Fast nonlinear dynamic compact thermal modeling with multiple heat sources in ultra-thin chip stacking technology,” IEEE Transactions on Components, Packaging and Manufacturing Technology, vol. 7, no. 1, 2016.

[12] Lorenzo Codecasa, Vincenzo d′Alessandro, Alessandro Magnani, and Niccolo Rinaldi, “Novel approach for the extraction of nonlinear compact thermal models,” in International Workshop on Thermal Investigations of ICs and Systems, 2017.

[13] RE Mortensen, “Nonlinear system theory: The volterra/wiener approach,” SIAM Review, vol. 25, no. 3, 1983.

[14] Charbel Farhat, Philip Avery, Todd Chapman, and Julien Cortial, “Dimensional reduction of nonlinear finite element dynamic models with finite rotations and energy-based mesh sampling and weighting for computational efficiency,” International Journal for Numerical Methods in Engineering, vol. 98, no. 9, 2014.

[15] Robert Eymard, Thierry Gallouet, and Raphaele Herbin, “Finite volume methods,” in Handbook of numerical analysis, vol. 7. Elsevier, 2000.

[16] Edoardo Amaldi, Viggo Kann, et al., “On the approximability of minimizing nonzero variables or unsatisfied relations in linear systems,” Theoretical Computer Science, vol. 209, no. 1, 1998.

[17] Yagyensh Chandra Pati, Ramin Rezaiifar, and Perinkulam Sambamurthy Krishnaprasad, “Orthogonal matching pursuit: Recursive function approximation with applications to wavelet decomposition,” Asilomar conference on signals, systems and computers, 1993.

It is to be noted that documents [1] through [17] are each incorporated by reference in their entirety.

Further details may be found in U.S. Pat. No. 9,384,315, entitled “Method, system and computer program product for electrical and thermal analysis at a substrate level”, issued on Jul. 5, 2016, the contents of which are incorporated by reference in their entirety.

While the disclosure has been described with respect to a limited number of embodiments, those skilled in the art, having benefit of this disclosure, will appreciate that other embodiments can be envisioned that do not depart from the scope of the disclosure as disclosed herein. Accordingly, the scope of the disclosure shall be limited only by the attached claims.

1. A method, comprising:
defining a non-linear heat diffusion problem for at least a portion of a semiconductor device to be modeled;
performing a finite volume discretization of the non-linear heat diffusion problem;
reformulating a non-linear term of the discretized non-linear heat diffusion problem to decrease dimensions thereof;
performing a hyper reduction of the reformulated non-linear term, and recovering the non-linear heat diffusion problem for the portion of the semiconductor device; and
causing manufacture of the modeled semiconductor device.

2. The method of claim 1, wherein performing the finite volume discretization includes defining interface nodes that represent interfaces between non-homogenous materials in the semiconductor device to be modeled.

3. The method of claim 2, wherein performing the finite volume discretization further comprises:
introducing an auxiliary variable to the non-linear heat diffusion problem to redefine the non-linear heat diffusion problem to contain only quadratic non-linearities;
splitting the portion of the semiconductor device to be modeled into a plurality of tetrahedrons;
collocating inner thermal nodes in centroids of each of the plurality of tetrahedrons;
collocating the interface nodes in centers of each contact surface between two adjacent tetrahedrons; and
deriving an interconnection structure from an electrical problem associated with the non-linear heat diffusion problem.

4. The method of claim 3, wherein deriving the interconnection structure comprises defining thermal resistance values between each inner thermal node and its adjacent interface node or nodes.

5. The method of claim 4, wherein performing the finite volume discretization mathematically yields:
$$C \frac{\partial }{\partial t} θ ( t ) + K θ ( t ) + Δ K ( θ ( t ) ⊗ λ ( t ) ) = GP ( t ) \\ {T}_{0} N \frac{\partial λ}{\partial t} ( t ) + Δ N ( θ ( t ) ⊗ \frac{\partial λ}{\partial t} ) = M \frac{\partial θ}{\partial t} ( t ) + Δ M ( \frac{\partial θ}{\partial t} ( t ) ⊗ λ ( t ) )$$
wherein C is a matrix that describes thermal capacity of the portion of the semiconductor device;
wherein K is a matrix that describes thermal conductivity between each of the plurality of tetrahedrons;
wherein G is a matrix that describes the power dissipation in each tetrahedron, each described powerful dissipation representing a fraction of a total power dissipation within the portion of the semiconductor device;
wherein θ(t) represents unknown temperature rises in the portion of the semiconductor device; and
wherein λ(t) is the auxiliary variable.

6. The method of claim 5,
wherein C is a diagonal matrix with each entry cᵢᵢ being nonzero provided that the index i refers to an inner thermal node, with i ranging from 1 to mₑ;
wherein K is a matrix having a size of mₑ by mₑ, with kᵢⱼ being equal to −rᵢ if i is not equal to j, with rᵢ being the resistance between a given inner thermal node and an interface node, and kᵢⱼ being a sum in absolute value of elements of the row ij if i=j;
wherein G is a diagonal matrix with each entry gᵢᵢ being nonzero provided that the index i refers to an inner thermal node, with i ranging from 1 to mₑ;
wherein N is an identity matrix having a size of m by m; and
wherein M is a diagonal matrix having a size of m by m where mᵢⱼ=σ(Nᵢ), with σ being a material dependent function.

7. The method of claim 6,
wherein the non-linear term has a size of mₑ by a product of m and mₑ)
wherein the non-linear term is reformulated by determining a squared matrix having a size of mₑ by mₑ.

8. The method of claim 7, wherein the non-linear term of the discretized non-linear heat diffusion problem is given by ΔK(θ(t)⊗λ(t)), with ΔK being non-linear;
wherein the non-linear term is reformulated as:
ΔK(θ(t)⊗λ(t))=A_{λ(t)}θ(t), with A_{λ(t)}θ(t) being the squared matrix.

9. The method of claim 8, wherein A_{λ(t)}θ(t) is computed by replacing each diagonal value kii of the matrix K with a non-linear resistance value of λ(Nᵢt)kᵢᵢ; and wherein each term λ(Nᵢ,t) is computed for the inner thermal nodes as:
$$λ ( {N}_{i} , t ) = {( 1 + \frac{θ ( {N}_{i} , t )}{{T}_{0}} )}^{σ ( {N}_{i} )} - 1.$$

10. The method of claim 9, wherein the hyper reduction of the reformulated non-linear term is performed by computing projection matrices able to derive a compact form for the discretized non-linear heat diffusion problem.

11. The method of claim 10, wherein the projection matrices are computed using non-linear model order reduction based upon moment matching and Krylov subspaces.

12. The method of claim 11, wherein the compact form for the discretized non-linear heat diffusion problem is:
$$\hat{C} \frac{\partial }{\partial t} \hat{θ} ( t ) + \hat{K} \hat{θ} ( t ) + Δ \hat{K} ( \hat{θ} ( t ) ⊗ \hat{λ} ( t ) ) = \hat{G} P ( t ) \\ {T}_{0} \hat{N} \frac{\partial \hat{λ}}{\partial t} ( t ) + Δ \hat{N} ( \hat{θ} ( t ) ⊗ \frac{\partial \hat{λ}}{\partial t} ) = \hat{M} \frac{\partial \hat{θ}}{\partial t} ( t ) + Δ \hat{M} ( \frac{\partial \hat{θ}}{\partial t} ⊗ \hat{λ} ( t ) ) .$$

13. The method of claim 12, wherein the projection matrices are defined as a matrix V having a size of \hat{m}×mₑ and a matrix W having a size of \hat{m}×m, where mₑ>m»\hat{m}.

14. The method of claim 13, wherein the hyper reduction of the reformulated non-linear term is further performed by defining reduced matrices as follows:
Ĉ=V^{T}CV \hat{m}×\hat{m}
\hat{K}=V^{T}KT \hat{m}×\hat{m}
Δ\hat{K}=V^{T}ΔK(V⊗W) \hat{m}×\hat{m}²
Ĝ=V^{T}G \hat{m}×\hat{m}
\hat{N}=W^{T}NW \hat{m}×\hat{m}
\hat{M}=W^{T}MV \hat{m}×\hat{m}
Δ\hat{N}=W^{T}ΔN(V⊗W) \hat{m}×\hat{m}²
Δ\hat{M}=W^{T}ΔM(V⊗W) \hat{m}×\hat{m}²

15. The method of claim 14,
wherein ΔK is calculated as: ΔK=Σᵢ₌₁^{m}Aₑ_{ᵢ}⊗eᵢ^{T};
wherein ΔM is calculated as: ΔM=Σᵢ₌₁^{m}M⊗eᵢ^{T}; and
wherein ΔN is calculated as: ΔN=Σᵢ₌₁^{m}N⊗eᵢ^{T},
where eᵢ=(0, . . . , 0, 1, 0, . . . , 0)^{T} is the ith vector of a basis of an m-dimensional Euclidean space.

16. The method of claim 15, wherein the reformulated non-linear matrix ΔK has a size of \hat{m}×\hat{m}²; and wherein the hyper reduction of the reformulated non-linear term is further performed by: applying energy-conserving sampling and weighting to the reformulated non-linear matrix ΔK, beginning with a collection of a snapshots of the solution to the non-linear heat diffusion problem in a set of complex frequencies in the Laplace domain, resulting in a matrix U having dimensions of mₑ×s and a matrix ∧ having dimensions of m×s.

17. The method of claim 16, wherein the hyper reduction of the reformulated non-linear term is further performed by construction of a matrix H and a vector b, as follows:
Hᵢₑ=V^{T}*∧(e,i)*Aₚₑ*U(:,i),
i=1, . . . , s
e=1, . . . , m
b=H*(1, . . . , 1)^{T};
and wherein resolution of a resulting sparse minimization problem is performed as:
ξ*=argmin_{ξ}∥Hξ−b∥_{F} s.t.ξ≥0 and ∥ξ∥₀<w
wherein a solution of the problem ξ* represents a sparse vector of weights, and a set E can defined as the indices of the non-zero entries of ξ*.

18. The method of claim 17, wherein the hyper reduction of the reformulated non-linear term is further performed by evaluating it on volumed indexed by E and weighted by ξ*, as follows:
Δ\hat{K}(\hat{θ}(t)⊗\hat{λ}(t))≈(Σₑ₌₁^{w}ξ*(e)*W(e,:)*\hat{λ}(t)*V^{T}Aₚₑ*V)*\hat{θ}(t).

19. The method of claim 18, wherein the hyper reduction of the reformulated non-linear term is further performed by performed by a singular value decomposition on the terms V^{T}* Aₚₑ*V for e=1, . . . , w.

20. The method of claim 19, wherein recovering the non-linear heat diffusion problem for the portion of the semiconductor device is performed by solving the hyper reduction of the reformulated non-linear term to produce a reduced solution of \hat{θ}(t) and \hat{λ}(t).

21. The method of claim 20, wherein recovering the non-linear heat diffusion problem for the portion of the semiconductor device is further performed by using the projection matrices V and W as:
θ(t)=V\hat{θ}(t) λ(t)=W\hat{λ}(t).

22. A method, comprising:
defining a non-linear heat diffusion problem for at least a portion of a semiconductor device to be modeled;
performing a finite volume discretization of the non-linear heat diffusion problem by:
defining interface nodes that represent interfaces between non-homogenous materials in the semiconductor device to be modeled
introducing an auxiliary variable to the non-linear heat diffusion problem to redefine the non-linear heat diffusion problem to contain only quadratic non-linearities;
splitting the portion of the semiconductor device to be modeled into a plurality of tetrahedrons;
collocating inner thermal nodes in centroids of each of the plurality of tetrahedrons;
collocating the interface nodes in centers of each contact surface between two adjacent tetrahedrons; and
deriving an interconnection structure from an electrical problem associated with the non-linear heat diffusion problem by defining thermal resistance values between each inner thermal node and its adjacent interface node or nodes.
reformulating a non-linear term of the discretized non-linear heat diffusion problem to decrease dimensions thereof;
performing a hyper reduction of the reformulated non-linear term by computing projection matrices able to derive a compact form for the discretized non-linear heat diffusion problem; and
recovering the non-linear heat diffusion problem for the portion of the semiconductor device from the compact form for the discretized non-linear heat diffusion problem.

23. The method of claim 22, wherein performing the finite volume discretization mathematically yields:
$$C \frac{\partial }{\partial t} θ ( t ) + K θ ( t ) + Δ K ( θ ( t ) ⊗ λ ( t ) ) = GP ( t ) \\ {T}_{0} N \frac{\partial λ}{\partial t} ( t ) + Δ N ( θ ( t ) ⊗ \frac{\partial λ}{\partial t} ) = M \frac{\partial θ}{\partial t} ( t ) + Δ M ( \frac{\partial θ}{\partial t} ( t ) ⊗ λ ( t ) ) ,$$
wherein C is a matrix that describes thermal capacity of the portion of the semiconductor device;
wherein K is a matrix that describes thermal conductivity between each of the plurality of tetrahedrons;
wherein G is a matrix that describes the power dissipation in each tetrahedron, each described powerful dissipation representing a fraction of a total power dissipation within the portion of the semiconductor device;
wherein θ(t) represents unknown temperature rises in the portion of the semiconductor device; and
wherein λ(t) is the auxiliary variable.

24. The method of claim 23,
wherein C is a diagonal matrix with each entry cᵢᵢ being nonzero provided that the index i refers to an inner thermal node, with i ranging from 1 to mₑ;
wherein K is a matrix having a size of mₑ by mₑ, with kᵢⱼ being equal to −rᵢ if i is not equal to j, with rᵢ being the resistance between a given inner thermal node and an interface node, and kᵢⱼ being a sum in absolute value of elements of the row ij if i=j;
wherein G is a diagonal matrix with each entry gᵢᵢ being nonzero provided that the index i refers to an inner thermal node, with i ranging from 1 to mₑ;
wherein N is an identity matrix having a size of m by m; and
wherein M is a diagonal matrix having a size of m by m where mᵢⱼ=σ(Nᵢ), with σ being a material dependent function.

25. The method of claim 24,
wherein the non-linear term has a size of mₑ by a product of m and mₑ)
wherein the non-linear term is reformulated by determining a squared matrix having a size of mₑ by mₑ.

26. The method of claim 25, wherein the non-linear term of the discretized non-linear heat diffusion problem is given by ΔK(θ(t)⊗λ(t)), with ΔK being non-linear;
wherein the non-linear term is reformulated as:
ΔK(θ(t)⊗λ(t))=A_{λt)}θ(t), with A_{λ(t)}θ(t) being the squared matrix.

27. The method of claim 26, wherein A_{λ(t)}θ(t) is computed by replacing each diagonal value kii of the matrix K with a non-linear resistance value of λ(Nᵢ,t)kᵢᵢ; and wherein each term λ(Nᵢ,t) is computed for the inner thermal nodes as:
$$λ ( {N}_{i} , t ) = {( 1 + \frac{θ ( {N}_{i} , t )}{{T}_{0}} )}^{σ ( {N}_{i} )} - 1 .$$

28. The method of claim 27, wherein the projection matrices are computed using non-linear model order reduction based upon moment matching and Krylov subspaces.
